(19) United States
(12) Patent Application Publication
(10) Pub. No.: US 2016/0026056 A1
(43) Pub. Date: Jan. 28, 2016

(54) COMPLEX FILM HAVING ELECTRO-CHROMIC MIRROR FUNCTION AND ANTI-REFELECTIVE FUNCTION, DISPLAY COMPROMISING THE COMPLEX FILM, AND METHODS OF MANUFACTURING THE COMPLEX FILM AND DISPLAY

(71) Applicant: Samsung Electronics Co., Ltd., Suwon-si (KR)

(72) Inventors: Bonwon KOO, Suwon-si (KR); Deukseok CHUNG, Yongin-si (KR); Hyunjoon KIM, Seoul (KR); Shanghyeun PARK, Yongin-si (KR); Changsoo LEE, Seoul (KR); Taewon JEONG, Yongin-si (KR)

(21) Appl. No.: 14/796,510

(22) Filed: Jul. 10, 2015

(30) Foreign Application Priority Data
Jul. 24, 2014 (KR) 10-2014-0094160

(51) Int. Cl. G02F 1/157; G02B 1/11; G02F 1/1335

(52) U.S. Cl. CPC G02F 1/157; G02F 1/133502; G02B 1/11

(57) ABSTRACT

Complex films having an electro-chromic mirror and an anti-reflective film, displays that include the complex films, and methods of manufacturing the complex films and the displays, include an electro-chromic mirror including a plurality of electro-chromic material layers, and an anti-reflective film including a plurality of anti-reflective material layers, wherein at least some of the plurality of anti-reflective material layers are between an uppermost layer and a lowermost layer of the plurality of electro-chromic material layers.

### RELATED APPLICATION

This application claims the benefit of, and priority, under 35 U.S.C. §119, to Korean Patent Application No. 10-2014-0094160, filed on Jul. 24, 2014, in the Korean Intellectual Property Office, the disclosure of which is incorporated herein in its entirety by reference.

### BACKGROUND

1. Field

Example embodiments relate to complex films having an electro-chromic mirror, apparatuses that use an electro-chromic mirror and methods of manufacturing the same, and more particularly, to complex films having an electro-chromic mirror and an anti-reflective film, displays that include the complex films, and methods of manufacturing the complex films and displays.

2. Description of the Related Art

An anti-reflective film and an electro-chromic mirror are placed on a surface of a display that faces the viewers, that is, on a frontal side of the display. The electro-chromic mirror operates in a transmission mode (a transparent mode) and a reflection mode (a mirror mode) according to the voltage characteristic of an applied power. That is, in an electro-chromic structure described below, the electro-chromic mirror operates in a transmission mode when a positive (+) voltage is applied to a transparent electrode, and operates in a reflective mode when a negative (−) voltage is applied to the transparent electrode. An electro-chromic device applies a voltage to the transparent electrode to change the mode of the electro-chromic mirror. After the mode is changed, power supply to the transparent electrode to maintain the mode of the electro-chromic mirror is unnecessary. In the transparent mode, a display image is transmitted to the viewers, and the display functions as a mirror in the reflection mode.

### SUMMARY

Example embodiments relate to complex films having an electro-chromic mirror, apparatuses that use an electro-chromic mirror and methods of manufacturing the same, and more particularly, to complex films having an electro-chromic mirror and an anti-reflective film, displays that include the complex films, and methods of manufacturing the complex films and displays.

Provided are complex films having an electro-chromic mirror and an anti-reflective film.

Provided are displays that have an increased value added and may be manufactured with low costs due to their simplified structure that allows manufacturing of a complex film that has a function of minimizing external and internal reflection in addition to an electro-chromic mirror function.

Provided are methods of manufacturing the complex film and the display including the same.

Additional aspects will be set forth in part in the description which follows and, in part, will be apparent from the description, or may be learned by practice of the presented example embodiments.

According to example embodiments, a complex film includes an electro-chromic mirror including a plurality of electro-chromic material layers; and an anti-reflective film including a plurality of anti-reflective material layers, wherein at least some of the plurality of anti-reflective material layers are between an uppermost layer and a lowermost layer of the plurality of electro-chromic material layers.

Others of the plurality of anti-reflective material layers may be on the uppermost layer of the plurality of electro-chromic material layers.

All of the plurality of anti-reflective material layers may be between the uppermost layer and the lowermost layer of the plurality of electro-chromic material layers.

The electro-chromic mirror may further include a base substrate that includes a transparent material, such as glass or plastic, on the base substrate; a transparent electrode on the base substrate; an ion storage film on the transparent electrode; an electrolyte film on the ion storage film; a catalyst layer on the electrolyte film; an active film on the catalyst layer; a first layer of the plurality of anti-reflective material layers between the base substrate and the transparent electrode; a second layer of the plurality of anti-reflective material layers between the ion storage film and the electrolyte film; and a third layer of the plurality anti-reflective material layers between the catalyst layer and the active film.

The first layer, the second layer, and the third layer may respectively include a mono layer or a multiple layer.

The anti-reflective film optionally disposed in the electro-chromic mirror may also function as a protective layer.

A first portion of the plurality of anti-reflective material layers may be between the transparent electrode and the ion storage film, and a second portion of the plurality of anti-reflective material layers may be between the electrolyte film and the catalyst layer.

The anti-reflective film may have a structure in which first and second layers of the plurality of anti-reflective material layers have different refractive indexes, and the first and second layers may be alternately stacked more than once.

According to some example embodiments, a complex film includes an electro-chromic mirror and a first anti-reflective film on an uppermost layer of the electro-chromic mirror.

The complex film may further include a second anti-reflective film on a bottom surface of the electro-chromic mirror.

The complex film may further include a protective layer between the active film and the catalyst layer, and between the catalyst layer and the electrolyte film.

According to other example embodiments, a display includes a light source; a display panel in front of the light source; a glass plate in front of the display panel; and the complex film described above in front of the glass plate.

According to further example embodiments, a method of manufacturing a complex film includes forming an electro-chromic mirror including a first plurality of layers on a substrate; and forming an anti-reflective film including a second plurality of layers on the substrate, wherein at first portion of the second plurality of layers are between the first plurality of layers.

A remaining portion of the second plurality of layers may be formed on an uppermost layer of the first plurality of layers.

The forming of the electro-chromic mirror on the substrate includes forming a transparent electrode on the substrate, forming an ion storage film on the transparent electrode, forming an electrolyte film on the ion storage film, forming a catalyst layer on the electrolyte film, and forming an active film on the catalyst layer.

The method may further including forming a first layer of the second plurality of layers between the substrate and the transparent electrode; forming a second layer of the second plurality of layers between the ion storage film and the electrolyte film; and forming a third layer of the second plurality of layers between the catalyst layer and the active film.

The method may further include forming a second portion of the second plurality of layers between the transparent electrode and the ion storage film; and a third portion of the second plurality of layers between the electrolyte film and the catalyst layer.

The anti-reflective film may have a structure in which first and second layers of the second plurality of layers have different refractive indexes, and the first and second layers are alternately stacked more than once.

According to still other example embodiments, a method of manufacturing a complex film includes forming the electro-chromic mirror on the substrate, stacking a first layer of the anti-reflective film on an uppermost layer of the electro-chromic mirror; and stacking remaining layers of the anti-reflective film on the first layer.

The method may further include additionally forming an anti-reflective film on a bottom surface of the substrate.

According to yet still other example embodiments, a method of manufacturing a display that includes a light source, a display panel in front of the light source, and a glass plate in front of the display panel, the method including manufacturing the complex film described above; and attaching the complex film to the glass plate.

### BRIEF DESCRIPTION OF THE DRAWINGS

Example embodiments will be more clearly understood from the following detailed description taken in conjunction with the accompanying drawings. FIGS. 1-8 represent non-limiting, example embodiments as described herein.

FIG. 1 is a perspective view of a display having an electro-chromic mirror according to example embodiments;

FIGS. 2 through 4 are cross-sectional views of complex films according to examples embodiments; and

FIGS. 5 through 8 are cross-sectional views for explaining a method of manufacturing a complex film having an electro-chromic mirror and an anti-reflective film and a method of manufacturing a display having an electro-chromic mirror.

### DETAILED DESCRIPTION

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments relate to complex films having an electro-chromic mirror, apparatuses that use an electro-chromic mirror and methods of manufacturing the same, and more particularly, to complex films having an electro-chromic mirror and an anti-reflective function, displays that include the complex films, and methods of manufacturing the complex films and displays.

Complex films having an electro-chromic mirror and an anti-reflective function according to example embodiments, displays or apparatuses having the complex film, and methods of manufacturing the complex film and display will be described with reference to the accompanying drawings. In the drawings, the thicknesses of layers and regions may be exaggerated for clarity.

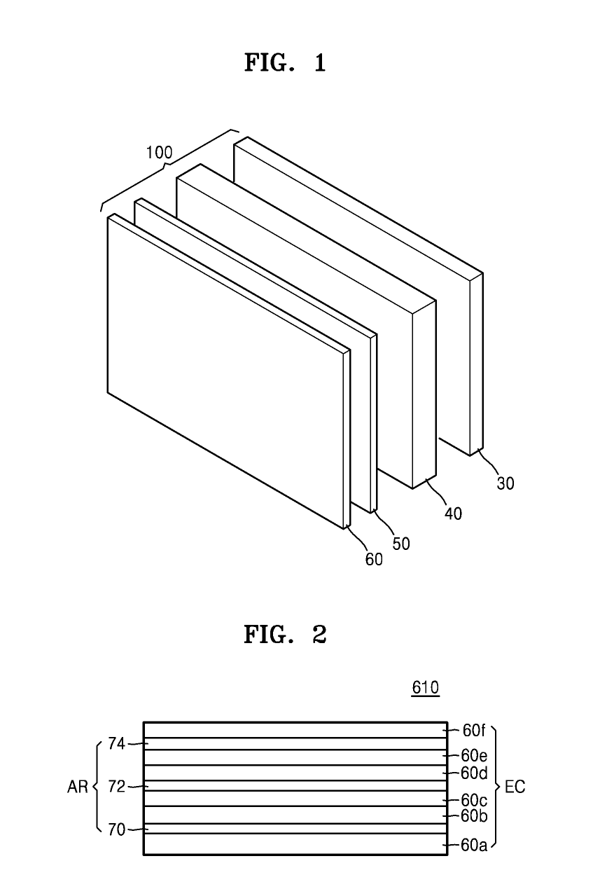

FIG. 1 is a perspective view of a display having an electro-chromic mirror according to example embodiments.

Referring to FIG. 1, a display 100 includes a light source 30, a display panel 40, a glass plate 50, and a complex film 60. The light source 30 is a light source that is generally used for flat displays, for example, a back light or a light-emitting diode (LED). The display 100 may be, for example, an LCD, an OLED, or a PDP.

The display panel 40 (hereinafter, the panel 40) corresponds to a main body of the display 100, and is located between the light source 30 and the glass plate 50. The display panel 40 may include all parts (elements) of the display 100 that are disposed between the light source 30 and the glass plate 50. The glass plate 50 may be formed of glass to protect a surface of the display 100 on which an image is formed. The glass plate 50 may include a polarizing layer. The complex film 60 is disposed in front of the glass plate 50. The glass plate 50 is optionally disposed between the complex film 60 and the display panel 40. The complex film 60 is attached to the glass plate 50 or the display panel 40. An image generated from the display panel 40 is transmitted to a viewer through the glass plate 50 and the complex film 60. The complex film 60 includes an electro-chromic mirror and an anti-reflective film AR, which will be described below.

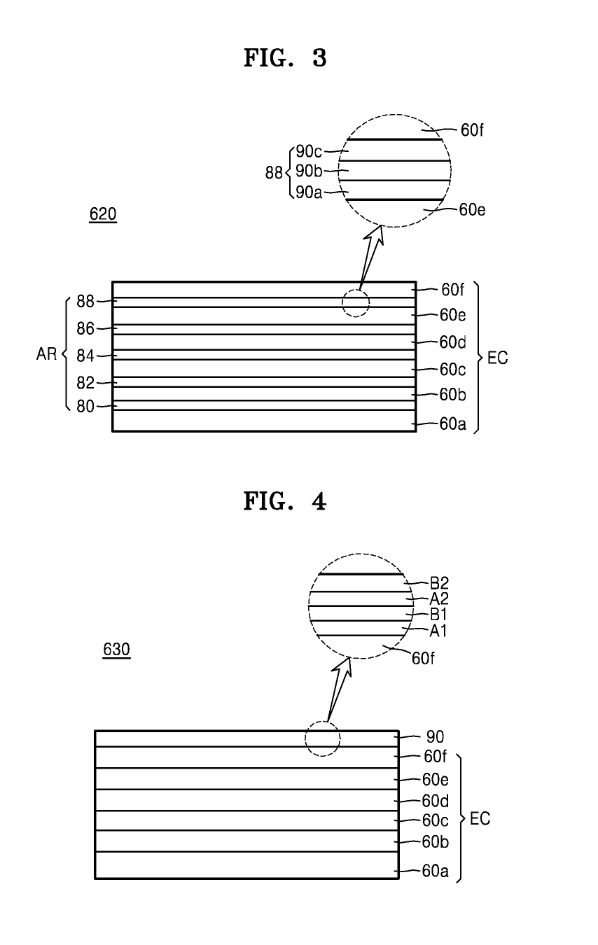

FIGS. 2 through 4 are cross-sectional views of complex films according to example embodiments.

FIG. 2 is a cross-sectional view of a complex film according to first example embodiments.

Referring to FIG. 2, a complex film 610 includes layers 70/72/74 that constitute an anti-reflective film AR and are placed between layers that constitute the electro-chromic mirror. That is, the layers that constitute the anti-reflective film AR are embedded in the electro-chromic mirror EC.

More specifically, referring to FIG. 2, the complex film 610 includes a base substrate 60a and a plurality of material layers stacked on the base substrate 60a. For example, a first layer 70 of the anti-reflective film is formed on the base substrate 60a. The base substrate 60a may be a glass substrate or a transparent plastic substrate. The transparent plastic substrate may include a plastic film selected from the group consisting of polyethersulphone (PES), polyacrylate (PAR), polyetherimide (PEI), polyethyelenennapthalate (PEN), polyethyeleneterepthalate (PET), polyphenylene sulfide (PPS), polyallylate, polyimide, polycarbonate (PC), tri-acetate cellulose (TAC), and cellulose acetate propinonate (CAP). The first layer 70 of the anti-reflective film may be a silicon nitride film or a silicon oxide film. The silicon nitride film may have a refractive index of approximately 1.98, and the silicon oxide film may have a refractive index of approximately 1.54. The thickness of the silicon nitride film or the silicon oxide film may be in a thickness range from about 200 nm to about 250 nm. The first layer 70 may be a mono layer of a multiple layer.

A transparent electrode 60b that is transparent to light is disposed on the first layer 70. The transparent electrode 60b may be, for example, an ITO film, or other transparent conductive oxide film similar to the ITO film. An ion storage film 60c is formed on the transparent electrode 60b. The ion storage film 60c stores protons. The ion storage film 60c may be, for example, a tungsten oxide film (WOx film). When a positive (+) voltage is applied to the transparent electrode 60b of the electro-chromic mirror, hydrogen ions (protons) included in the ion storage film 60c move upwards and reach an active film 60f after passing through an electrolyte film 60d and a catalyst layer 60e. As a result, the ion storage film 60c and the active film 60f become a transparent state. However, when a negative (−) voltage is applied to the transparent electrode 60b of the electro-chromic mirror, the protons that reach the active film 60f move to the ion storage film 60c. As a result, the active film 60f returns to its original metal characteristic, and the ion storage film 60c is changed again to a deep blue state by the protons, that is, it is colored to become opaque. When the negative voltage is applied, the complex film 610 functions as a mirror.

Next, a second layer 72 of the anti-reflective film is disposed on the ion storage film 60c. The second layer 72 may be, for example, a silicon nitride film or a silicon oxide film. The silicon nitride film may have a refractive index of approximately 1.98, and the silicon oxide film may have a refractive index of approximately 1.54. The thickness of the silicon nitride film or the silicon oxide film may be below 50 nm. The second layer 72 may be a different material layer from the first layer 70. For example, when the first layer 70 is a silicon oxide film (for example, a SiOx film), the second layer 72 may be a silicon nitride film, and vice versa. The second layer 72 may be a single layer or a multiple layer. The electrolyte film 60d is disposed on the second layer 72. The electrolyte film 60d may be, for example, a TaOx film or a SnInPOx film. The catalyst layer 60e is disposed on the electrolyte film 60d. The catalyst layer 60e may include one element selected from the group consisting of Pd, Pt, and Au. Due to the presence of the catalyst layer 60e, when the electro-chromic mirror is in an “ON” state, a reaction between the active film 60f and protons that move from the ion storage film 60c to the active film 60f is promoted, and may take place uniformly on the entire region of the active film 60f. A third layer 74 of the anti-reflective film is disposed on the catalyst layer 60e. Regarding a refractive index, the third layer 74 may be a different material film from the second layer 72. However, the third layer 74 may be the same material film as the first layer 70 in a refractive index. The third layer 74 may be a single layer, or a multiple layer. The anti-reflective film AR may be formed by alternately stacking two material films having different refractive indexes like the first through third layers 70, 72, and 74. In FIG. 2, for convenience of explanation, the anti-reflective film AR includes the first through third layers 70, 72, and 74. However, the anti-reflective film AR may include three or more layers by alternately stacking more than twice of two material films having different refractive indexes. The thickness of each of the first through third layers 70, 72, and 74 and the total thickness of the first through third layers 70, 72, and 74 may be in a range of thickness that do not interfere the transmission/reflection action of the electro-chromic mirror. For example, the thickness of each of the second and third layers 72, and 74 that are disposed between the ion storage film 60c and the active film 60f, and the total thickness may be in a range that does not affect the motion of the hydrogen ions between the ion storage film 60c and the active film 60f, for example, below 50 nm.

Next, the active film 60f is disposed on the third layer 74. The active film 60f may be a film that includes at least two elements selected from the group consisting of Mg, Y, Ni, Ca, Gd, Sm, and Er. A material of the active film 60f may be an alloy material that may be in a transparent state by combining with protons supplied from the ion storage film 60c. The active film 60f may be formed of an alloy and acts as an upper electrode. In the complex film 610 of FIG. 2, the first through third layers 70, 72, and 74 may constitute an anti-reflective film AR, and the remaining layers 60a-60f may function as a single electro-chromic mirror EC, or a plurality of electro-chromic mirrors EC.

As depicted in FIG. 2, the complex film 610 has a layer structure in which each of the first through third layers 70, 72, and 74, which constitute the anti-reflective film AR, are embedded between the layers 60a-60f that constitute the electro-chromic mirror(s). Thus, by combining the anti-reflective film and the electro-chromic mirror(s) into a single layer, the number of constituent elements of the display 100 may be reduced, and also, the manufacturing process may be simplified.

In the case of the complex film 610 depicted in FIG. 2, the layers that constitute the anti-reflective film AR are not present between all of the layers that constitute the electro-chromic mirror(s) EC. In other words, in the complex film 610 depicted in FIG. 2, a single material film or two material films may be present between the first through third layers 70, 72, and 74 that constitute the anti-reflective film AR.

FIG. 3 is a cross-sectional view of a complex film according to second example embodiments.

In a complex film 620 depicted in FIG. 3, each of the layers 80, 82, 84, 86 and 88 constituting an anti-reflective film is disposed between all of the layers 60a-60f that constitute the electro-chromic mirror(s) EC. That is, the layers that constitute the electro-chromic mirror(s) EC and the layers 80, 82, 84, 86 and 88 that constitute the anti-reflective film AR are alternately disposed each other.

More specifically, referring to FIG. 3, a first layer 80 is disposed on the base substrate 60a. The first layer 80 may correspond to the first layer 70 of FIG. 2. The transparent electrode 60b is disposed on the first layer 80. A second layer 82 is disposed on the transparent electrode 60b. The second layer 82 may correspond to the second layer 72 of FIG. 2. The second layer 82 may have the same or a different thickness from the first layer 80. The ion storage film 60c is disposed on the second layer 82, and a third layer 84 is disposed on the ion storage film 60c. The third layer 84 may be formed of the same material as the first layer 80, but may have a different thickness from that of the first layer 80. The electrolyte film 60d is disposed on the third layer 84. A fourth layer 86 is disposed on the electrolyte film 60d. The fourth layer 86 may be formed of the same material as the second layer 82, but may have the same or different thickness from the second layer 82. The catalyst layer 60e is disposed on the fourth layer 86, and a fifth layer 88 is disposed on the catalyst layer 60e. The fifth layer 88 may be formed of the same material layer as the first layer 80. The fifth layer 88 may have a thickness equal to or different from that of one of the first through fourth layers 80, 82, 84, and 86. The active film 60f is disposed on the fifth layer 88.

A plurality of layers may further be included between the fifth layer 88 and the active film 60f. The plurality of layers may be layers in which a material layer equivalent to the second layer 82 and a material layer equivalent to the third layer 84 are sequentially stacked on the fifth layer 88. As a result, as shown in the magnified view, the fifth layer 88 may be substituted by an odd number (for example, three layers) of stacked material layers 90a, 90b, and 90c of the layers that constitute an anti-reflective film AR. In this case, the lower layer 90a and the upper layer 90c may be formed of the same material layer as the first layer 80, and the middle layer 90b may be formed of the same material layer as the second layer 82.

In the same manner, at least one layer selected from the first through fourth layers 80, 82, 84, and 86 may be substituted by an odd number (for example, three layers) of material layers of the layers that constitute an anti-reflective film AR. The odd number of material layers may be a reference layer (for example, 90a) and two layers (for example, 90b and 90c) on or below the reference layer. Of the two layers, a layer (for example, 90b) that contacts the reference layer may be formed of a different material layer from that of the reference layer, and the other layer (for example, 90c) that does not contact the reference layer may be formed of the same material layer as the reference layer. The first through fifth layers 80, 82, 84, 86, and 88 may constitute an anti-reflective film AR. Although not shown, a portion of the anti-reflective film AR may be present on the active film 60f and may function as a protection film.

As in the case of FIGS. 2 and 3, because the first through fifth layers 80, 82, 84, 86, and 88 that constitute the anti-reflective film AR are disposed between the layers 60a-60f that constitute the electro-chromic mirror(s) EC, both a surface reflection and an internal reflection of the display 100 may be reduced. Accordingly, the display 100 may provide high quality images.

The thickness of each of the first through fifth layers 80, 82, 84, 86, and 88 and the total thickness of the first through fifth layers 80, 82, 84, 86, and 88 may be in a range of thickness that does not affect the transmission/reflection function of the electro-chromic mirror.

FIG. 4 is a cross-sectional view of a complex film according to third example embodiments.

In a complex film 630 depicted in FIG. 4, an anti-reflective film is not embedded in an electro-chromic mirror(s) EC. In FIG. 4, like reference numerals are used to indicate same elements as described with reference to the FIGS. 1, 2 and 3, and thus, the detailed description thereof will not be repeated.

More specifically, referring to FIG. 4, a transparent electrode 60b is disposed on a base substrate 60a. An ion storage film 60c, an electrolyte film 60d, a catalyst layer 60e, and an active film 60f are sequentially stacked on the transparent electrode 60b. The films 60b through 60f sequentially stacked on the base substrate 60a may contact a respective one of the adjacent films. However, another material film may further be included between the adjacent films. An anti-reflective film 90 is formed on the active film 60f. The anti-reflective film 90 may be a single layer or a multiple layer. When the anti-reflective film 90 is a multiple layer, the anti-reflective film 90 may include sequentially coated first through fourth layers A1, B1, A2, and B2. The first and third layers A1 and A2 may be formed of the same material, and the second and fourth layers B1 and B2 may be formed of the same material. The first layer A1 may be, for example, one selected from the group consisting of a silicon nitride film or a silicon oxide film, and the second layer B1 may be the remaining one. The anti-reflective film 90 may have a thickness that does not adversely affect the operation of the electro-chromic mirror.

Also, in FIG. 4, a second anti-reflective film (not shown) may further be formed between the base substrate 60a and the transparent electrode 60b. Thus, a surface reflection and an internal reflection may be prevented, or reduced.

Next, a method of manufacturing the display according to example embodiments will be presented.

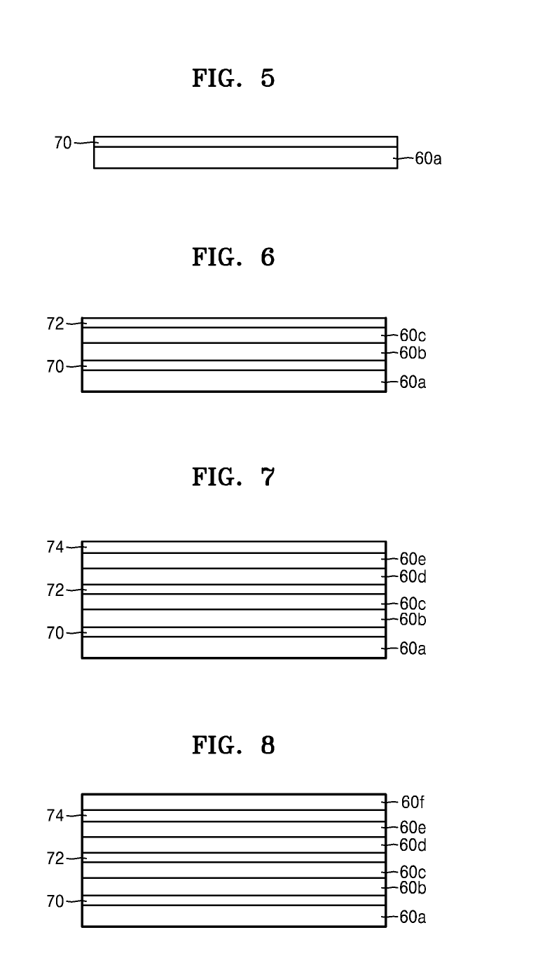

More specifically, a method of manufacturing the complex film of the display shown in FIG. 1 will be described with reference to FIGS. 5 through 8.

In FIGS. 5 through 8, like reference numerals are used to indicate the same elements as described with reference to the FIGS. 1, 2, and 3, and thus the detailed description thereof will not be repeated.

Referring to FIG. 5, a first layer 70 is formed on a base substrate 60a. The base substrate 60a may be formed of the material described above. The first layer 70 may be formed to have a set (or predetermined) thickness, for example, less than 50 nm.

Next, as depicted in FIG. 6, a transparent electrode 60b is formed on the first layer 70. An ion storage film 60c is formed on the transparent electrode 60b, and a second layer 72 is formed on the ion storage film 60c.

Referring to FIG. 7, an electrolyte film 60d is formed on the second layer 72, and a catalyst layer 60e is formed on the electrolyte film 60d. A third layer 74 is formed on the catalyst layer 60e. As depicted in FIG. 8, an active film 60f is formed on the third layer 74. A complex film 60 formed in this way is attached to a glass plate 50 of FIG. 1 via an optically clear adhesive.

According to other example embodiments, a portion of an anti-reflective film (for example, the second layer 82 of FIG. 3) may further be formed between the transparent electrode 60b and the ion storage film 60c as shown in FIG. 3, and also, a portion of an anti-reflective film (for example, the fourth layer 86 of FIG. 3) may further be formed between the electrolyte film 60d and the catalyst layer 60e. As a result, the complex film 620 of FIG. 3 may be formed.

According to still other example embodiments, instead of the first through third layers 70, 72, and 74, the transparent electrode 60b, the ion storage film 60c, the electrolyte film 60d, the catalyst layer 60e, and the active film 60f are sequentially formed on the base substrate 60a, and the anti-reflective film 90 may be formed on the active film 60f. In this manner, the complex film 630 of FIG. 4 may be formed.

In the method of manufacturing the display described above, processes other than the method of manufacturing the display may be generally processes in the art. Also, the films (layers) included in the complex film 60 may be formed by using a sputtering method. Also, the films (layers) may be formed by using other appropriate stacking methods in consideration of the material characteristics of the films (layers).

In the related art, an anti-reflective film is attached on a most frontal surface of a display panel, and when a film or a glass plate that functions as an electro-chromic mirror is employed, an additional attachment process is required.

However, the display according to example embodiments includes a single film (a complex film) that has an electro-chromic mirror(s) and an anti-reflective film. Accordingly, the display according to example embodiments may include a reduced number of constituent elements, and thus, the value-added of the display may increase. Also, the method of manufacturing the display may be simplified along with a reduction of the manufacturing costs.

It should be understood that the exemplary embodiments described therein should be considered in a descriptive sense only and not for purposes of limitation. Descriptions of features or aspects within example embodiments should typically be considered as available for other similar features or aspects in other example embodiments.

While one or more example embodiments have been described with reference to the figures, it will be understood by those of ordinary skill in the art that various changes in form and details may be made therein without departing from the spirit and scope of the disclosure as defined by the following claims.

What is claimed is:

1. A complex film, comprising:
an electro-chromic mirror including a plurality of electro-chromic material layers; and
an anti-reflective film including a plurality of anti-reflective material layers,
wherein at least some of the plurality of anti-reflective material layers are between an uppermost layer and a lowermost layer of the plurality of electro-chromic material layers.

2. The complex film of claim 1, wherein others of the plurality of anti-reflective material layers are on the uppermost layer of the plurality of electro-chromic material layers.

3. The complex film of claim 1, wherein all of the plurality of anti-reflective material layers are between the uppermost layer and the lowermost layer of the plurality of electro-chromic material layers.

4. The complex film of claim 1, wherein the electro-chromic mirror further includes,
a base substrate;
a transparent electrode on the base substrate;
an ion storage film on the transparent electrode;
an electrolyte film on the ion storage film;
a catalyst layer on the electrolyte film;
an active film on the catalyst layer;
a first layer of the plurality of anti-reflective material layers between the base substrate and the transparent electrode;
a second layer of the plurality of anti-reflective material layers between the ion storage film and the electrolyte film; and
a third layer of the plurality of anti-reflective material layers between the catalyst layer and the active film.

5. The complex film of claim 4, wherein a first portion of the plurality of anti-reflective material layers is between the transparent electrode and the ion storage film, and
a second portion of the plurality of anti-reflective material layers is between the electrolyte film and the catalyst layer.

6. The complex film of claim 1, wherein the anti-reflective film has a structure in which first and second layers of the plurality of anti-reflective material layers have different refractive indexes, and
the first and second layers are alternately stacked more than once.

7. A display, comprising:
a light source;
a display panel in front of the light source;
a glass plate in front of the display panel; and
the complex film according to claim 1, wherein the complex film is in front of the glass plate.

8. A complex film, comprising:
an electro-chromic mirror; and
a first anti-reflective film on an uppermost layer of the electro-chromic mirror.

9. The complex film of claim 8, further comprising:
a second anti-reflective film on a bottom surface of the electro-chromic mirror.

10. A display, comprising:
a light source;
a display panel in front of the light source;
a glass plate in front of the display panel; and
the complex film according to claim 8, wherein the complex film is in front of the glass plate.

11. A method of manufacturing a complex film, the method comprising:
forming an electro-chromic mirror including a first plurality of layers on a substrate; and
forming an anti-reflective film including a second plurality of layers on the substrate;
wherein a first portion of the second plurality of layers are between the first plurality of layers.

12. The method of claim 11, wherein a remaining portion of the second plurality of layers are formed on an uppermost layer of the first plurality of layers.

13. The method of claim 11, wherein the forming of the electro-chromic mirror on the substrate includes,
forming a transparent electrode on the substrate,
forming an ion storage film on the transparent electrode,
forming an electrolyte film on the ion storage film,
forming a catalyst layer on the electrolyte film, and
forming an active film on the catalyst layer.

14. The method of claim 13, further comprising:
forming a first layer of the second plurality of layers between the substrate and the transparent electrode;
forming a second layer of the second plurality of layers between the ion storage film and the electrolyte film; and
forming a third layer of the second plurality of layers between the catalyst layer and the active film.

15. The method of claim 14, further comprising:
forming a second portion of the second plurality of layers between the transparent electrode and the ion storage film; and
a third portion of the second plurality of layers between the electrolyte film and the catalyst layer.

16. The method of claim 11, wherein the anti-reflective film has a structure in which first and second layers of the second plurality of layers have different refractive indexes, and
the first and second layers are alternately stacked more than once.

17. A method of manufacturing a display including a light source, a display panel in front of the light source, and a glass plate in front of the display panel, the method comprising:
manufacturing a complex film according to the method according to claim 11; and
attaching the complex film to the glass plate.

18. A method of manufacturing a complex film, the method comprising:
forming the electro-chromic mirror on the substrate;
stacking a first layer of the anti-reflective film on an uppermost layer of the electro-chromic mirror; and
stacking remaining layers of the anti-reflective film on the first layer.

19. The method of claim 18, further comprising:
additionally forming an anti-reflective film on a bottom surface of the substrate.

20. A method of manufacturing a display including a light source, a display panel in front of the light source, and a glass plate in front of the display panel, the method comprising:
manufacturing a complex film according to the method according to claim 18; and
attaching the complex film to the glass plate.
